(19) United States
(12) Patent Application Publication
(10) Pub. No.: US 2007/0072686 A1
(43) Pub. Date: Mar. 29, 2007

(54) Torsion shock absorber

(76) Inventors: David G. Peot, Easley, SC (US); E. Lee Watson, Greenville, SC (US)

Correspondence Address: BRINKS HOFER GILSON & LIONE, P.O. BOX 10395, CHICAGO, IL, 60610, US

(21) Appl. No.: 11/238,927

(22) Filed: Sep. 29, 2005

(51) Int. Cl. F16D 3/12

(52) U.S. Cl. 464/57

(57) ABSTRACT

A device for minimizing damage to an electronic article resulting from an overload or jamming of the article that includes a shaft; a driven element carried on the shaft; a clutch plate carried on the shaft; and a torsion spring surrounding a portion of the shaft and having a first end connected to the clutch plate and a second end connected to the driven element such that the spring is windable by a first torque that is greater than a second torque and wherein the second torque produces an operating rotation of the driven element.

### BACKGROUND OF THE INVENTION

The present invention relates to motor powered devices and it includes a torsional shock absorber that may be able to prevent or minimize damage from sudden deceleration caused by jamming of the device being driven by the motor. The torsional shock absorbers can be used with hedge trimmers, drills, and other similar motor powered devices.

One problem with motor powered devices used to power hedge trimmers and the like is that they may become jammed that results in a sudden deceleration that may cause damage to one or more of the parts of the motor powered device. Therefore, it is desirable to provide a means to reduce or prevent damage resulting from the sudden deceleration.

### SUMMARY

According to the present invention, a device for minimizing mechanism damage to motor powered article resulting from an overload or jamming of the article includes a torsion spring absorber that includes a driven element, a clutch plate, and a torsion spring connecting the driven element and the clutch plate. The torsion spring is preloaded to that the spring is windable by a first torque that is greater than a second torque and wherein the second torque produces normal functioning of the article.

Desirably, a shaft is provided to carry the driven element and the clutch plate in a coaxial fashion. The clutch plate is securely connected to the shaft so that it rotates with the shaft. The driven element may be in the form of a gear that is driven by a driving element in the form of a pinion. The driven element is capable of slight relative movement with respect to the clutch plate. As a result, if the driven element is being driven and thus the clutch and shaft are rotating and there is a sudden deceleration causing one of the driven element or the clutch plate to stop, the torsion spring will wind, absorb and dissipate the energy and slow the rotation of the one of the driven element or clutch plate until it stops.

### BRIEF DESCRIPTION OF THE DRAWINGS

FIG. 1 is a side view of the torsion shock absorber of the present invention.

FIG. 2 is a cross sectional view of the absorber shown in FIG. 1 taken along line 2-2.

FIG. 3 is a cross sectional view of the absorber shown in FIG. 1 taken along line 3-3.

FIG. 4 is a cross sectional view of the absorber shown in FIG. 1 taken along line 4-4 and with the torsion spring removed to better illustrate features of the invention.

FIG. 5 is a side schematic of another embodiment of the torsion shock absorber of the present invention.

FIG. 6 is a side schematic of another embodiment of the torsion shock absorber of the present invention.

### DESCRIPTION

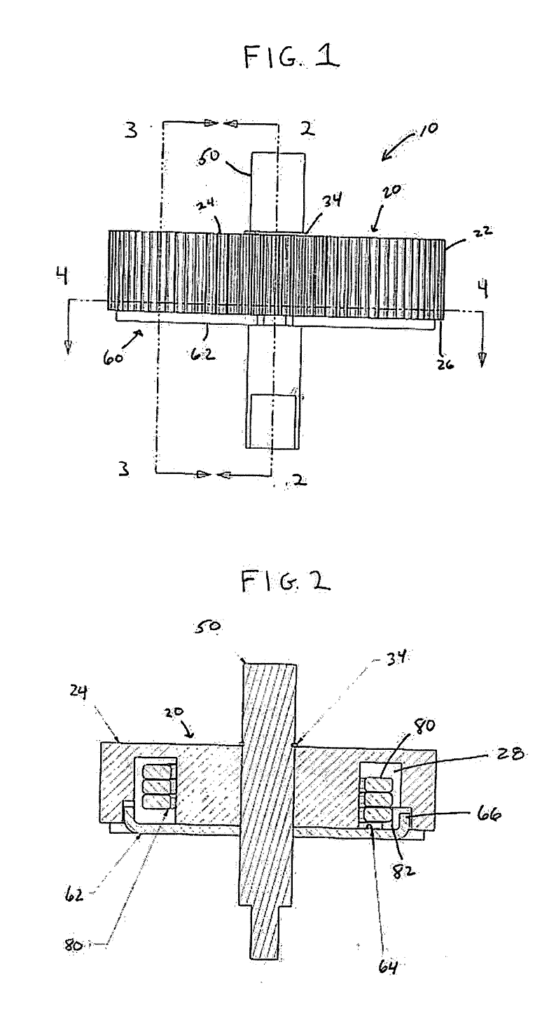

Turning now to FIG. 1, a torsion shock absorber 10 according to the present invention is shown. The torsion shock absorber 10 includes a driven element 20, a clutch plate 60, and a torsion spring 80 connecting the driven element 20 and the clutch plate 60. The driven element 20 and the clutch plate 60 can be carried by a shaft 50 and can be coaxially aligned with each other.

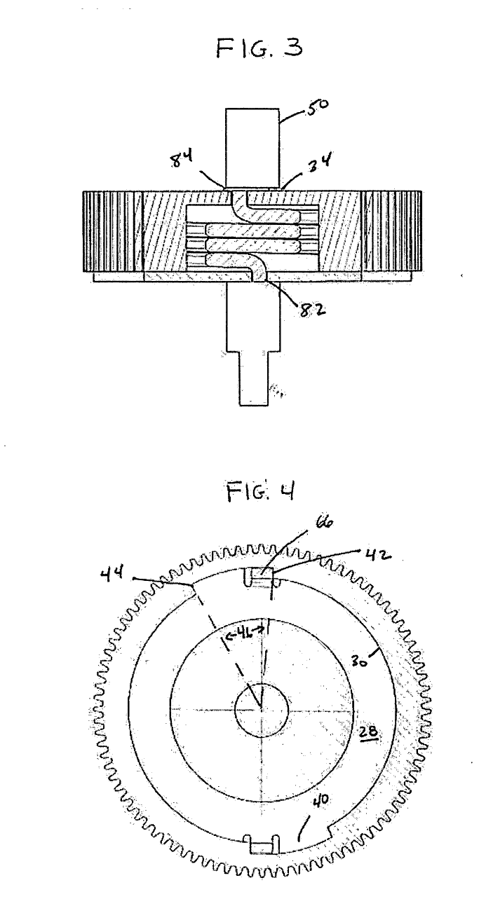

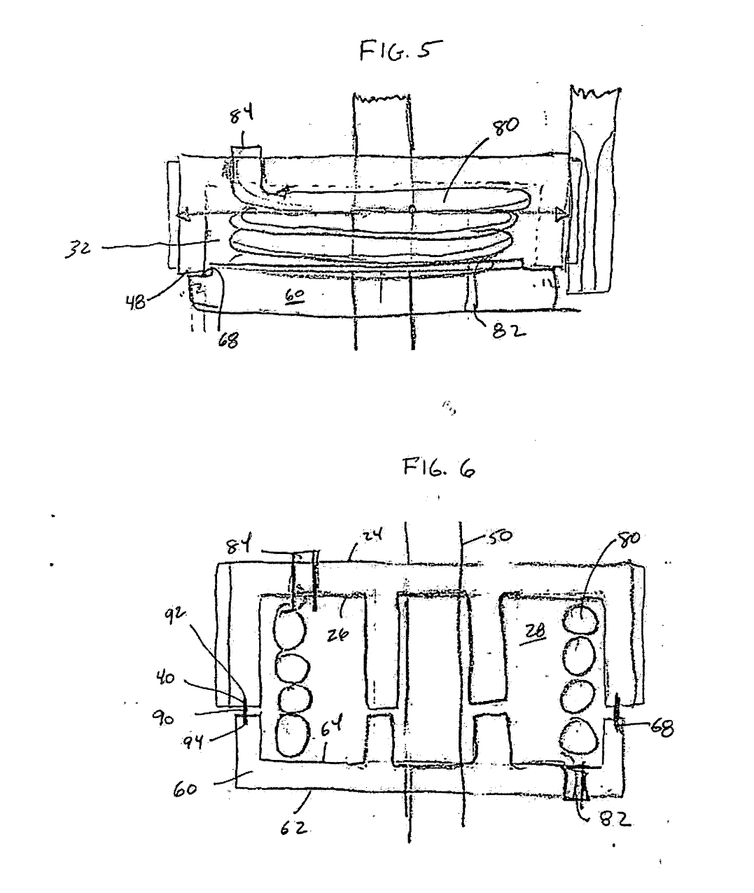

The driven element 20 is typically in the form of a gear having teeth 22, which can be driven by a pinion (not shown) in a conventional manner. The driven element 20 has a first side 24 and a second side 26. In one embodiment shown in FIGS. 2, 3, and 6, the second side 26 includes an annulus 28 that extends around an inner 30 portion of the driven element 20 to receive a spring 80, as will be described below. In another embodiment, shown in FIG. 5, the second side 26 is simply provided with a cavity 32. The driven element 20 is held in a suitable axial location by a retaining ring 34 or other securing device on the first side 24 and by the clutch plate 60 on the second side 26.

The second side 26 of the driven element 20 has at least one slot 40 and may have two slots. The slot has a first end wall 42 and a second end wall 44. The slot 40 may be provided on the inner periphery 30 of the driven element. As will become clear when referring to the following description, the slot 40 allows slight relative movement between the driven element 20 and the clutch plate 60. The slot 20 extends along only a portion of the circumference. In one embodiment, the slot extends along an arc 46 of about 90°, suitably about 45°, and may extend along an arc 46 of about 30°. Where two slots 40 are provided, they will be opposed to each other and will extend along an arc 46 about the same extent.

As noted above, the torsion shock absorber 10 also includes a clutch plate 60 that can be carried on the shaft 50 coaxially with the driven element 20 and may be carried in any known manner. Suitably, the clutch plate 60 will rotate with and in the same direction as the driven element 20. Accordingly, the clutch plate 60 is fixed to the shaft 50 in a suitable manner such as by press fitting or welding.

The clutch plate 60 has a first side 62 and a second side 64 with the second side 64 facing the second side 26 of the driven element 20. The clutch plate 60 has at least one and may have two tabs 66 that extend from the second side 64 of the clutch plate 60. The tab 66 extends into the slot 40. Because the slot 40 extends along a portion of the circumference of the driven element 20, the driven element 20 can have a slight relative movement with respect to the clutch plate 60. For example, should a tab 66 be in contact with the first end wall 42 of the slot 40, the driven element 20 can be rotated in one direction (the counter clockwise direction in FIG. 4) without movement of the clutch plate 60 or shaft 50 until the second end wall 44 of the slot 40 contacts the tab 64. On the other hand, if the driven element 20 were to be rotated in the other direction (the clockwise direction in FIG. 4), the clutch plate 60 and thus the shaft 50 would rotate with the driven element 20.

A torsional spring 80 having a first end 82 and a second end 84 is provided between the driven element 20 and the clutch plate 60. The torsional spring 80 is wound in a manner such that it surrounds the shaft 50. In one embodiment, best illustrated in FIGS. 2 and 6, the torsional spring 80 is located in the annulus 28 of the driven element 20. In another embodiment, best seen in FIG. 5, where the driven element 20 does not have an annulus 28, the torsion spring 80 resides in the cavity 32 of the driven element 20.

The first end 82 of the torsion spring 80 is connected to a portion of the second side 64 of the clutch plate 60. The first end 82 of the torsion spring 80 may be connected in any suitable manner such that the first end 82 is securely held to the clutch plate 60. For example, the first end 82 may be welded to the clutch plate 60 or it may fit into a complementary sized cavity.

The second end 84 of the torsion spring 80 is connected to a portion of the second side 26 of the driven element 20. The second end 84 may be connected in any suitable manner such that the second end 84 is securely held to the portion of the driven element 20.

In operation, the torsion shock absorber 10 reduces or prevents mechanism damage from sudden deceleration caused by sudden overloads or jamming. The torsion spring 10 is preloaded so that the torque needed to further wind the spring tighter is greater than the normal working load or torque. In other words, after one of the first 42 or second end 44 walls of the slot 40 (depending on the direction of travel) contacts a tab 66 of the clutch plate 60, the clutch plate 60 will rotate with the driven element 20 under a normal working load or torque and will not be precluded from rotation by the spring 80.

When, however, the driven element 20 or the shaft 50 is jammed or rapidly overloaded, the energy stored in the armature (not shown) is transferred to the clutch plate 60, which winds the spring 80 tighter and thus slows the deceleration of the armature. As a result, the forces on the driven element 20 are dissipated over a longer period of time and damage to the motor, gears, plates, bearings, and other mechanical parts connected to the driven element 20 can be minimized or prevented.

The deceleration energy is then stored in the torsion spring 80 and the torsion spring 80 will remain in its wound position by the normal stalled torque of the motor because the torsion spring 80 is provided with a spring constant substantially the same as the normal stalled torque of the motor. When the motor is released, the energy stored in the spring will be sufficient to overcome the normal friction of the drive system components and the spring and will then drive the motor in reverse, until it comes to rest. This reverse motion will, in turn, store rotational energy in the armature and as the motor and thus the gearing spins in reverse that motion will act to dislodge the jam.

Turning now to FIG. 5, another embodiment of the present invention is shown. In this embodiment, the clutch plate 60 is provided with has at least one slot 68 and may have two slots in the same manner as described above with respect to the slots provided on the driven element. Accordingly, the slot 68 has a first end wall (not shown) and a second end wall (not shown). The slot 68 extends along only a portion of the circumference. In one embodiment, the slot extends along an arc of about 90°, suitably about 45°, and may extend along an arc of about 30°. Where two slots are provided, they will be opposed to each other and will extend along an arc about the same extent.

In this embodiment, the driven element 20 is provided with at least one tab 48 and may have two tabs that extend from the second side 26 of the driven element 20. The tab 48 extends into the slot 68. Because the slot 68 extends along a portion of the circumference of the driven element 20, the driven element 20 can have a slight relative movement with respect to the clutch plate 60, as described above.

In another embodiment shown in FIG. 6, a connecting element 90 is provided with a first end 92 and a second end 94. The first end 92 or the second end 94 may be secured to one of the driven element 20 or the clutch plate 60, respectively. Where the first end 92 is secured to the driven element 20, the clutch plate 60 will be provided with a slot 68 in the same manner as described above so that the second end 94 of the connecting element 90 can travel in the slot 68. Alternatively, when the second end 94 is secured to the clutch plate 60, the driven element 20 will be provided with a slot 40 in the same manner as described above so that the first end 92 of the connecting element 90 can travel in the slot 40.

Of course, it should be understood that a wide range of changes and modifications could be made to the embodiments described above. It is therefore intended that the foregoing detailed description be regarded as illustrative rather than limiting, and that it be understood that it is the following claims, including all equivalents, that are intended to define the spirit and scope of this invention.

What is claimed is:

1. A torsion shock absorber comprising:
a. a shaft;
b. driven element carried on the shaft;
c. a clutch plate carried on the shaft;
d. a torsion spring surrounding a portion of the shaft and having a first end connected to the clutch plate and a second end connected to the driven element such that the spring is windable by a first torque that is greater than a second torque and wherein the second torque produces an operating rotation of the driven element.

2. The absorber of claim 1 wherein the clutch plate is secured to the shaft.

3. The absorber of claim 2 wherein the driven element is capable of relative rotational movement with respect to the clutch plate.

4. The absorber of claim 3 wherein the driven element has at least one slot formed on one side.

5. The absorber of claim 4 wherein the slot extends around a portion of the circumference of the driven element.

6. The absorber of claim 5 wherein an arc defining the extent the slot extends around the circumference of the driven element is less than about 90°.

7. The absorber of claim 4 wherein a portion of the clutch plate engages the at least one slot.

8. The absorber of claim 4 wherein the clutch plate further includes at least one tab extending from the clutch plate and engaging the at least one slot.

9. The absorber of claim 3 wherein the clutch plate has at least one slot formed on one side.

10. The absorber of claim 9 wherein the slot extends around a portion of the circumference of the clutch plate.

11. The absorber of claim 9 wherein a portion of the driven element engages the at least one slot.

12. The absorber of claim 9 wherein the driven element further includes at least one tab extending from the driven element and engaging the at least one slot.

13. The absorber of claim 3 further including a connecting element to connect a portion of the driven element with a portion of the clutch plate.

14. The absorber of claim 13 wherein the connecting element has a first end and a second end.

15. The absorber of claim 14 wherein the first end is secured to a portion of the driven end and the second end travels in a slot formed in the clutch plate.

16. The absorber of claim 14 wherein the second end is secured to a portion of the clutch plate and the first end travels in a slot formed in the driven element.
